(19) United States
(12) Patent Application Publication
(10) Pub. No.: US 2014/0002956 A1
(43) Pub. Date: Jan. 2, 2014

(54) HIGH ENERGY DENSITY ELECTROCHEMICAL CAPACITOR

(71) Applicant: Daniel Qi TAN, Niskayuna, NY (US)

(72) Inventor: Daniel Qi TAN, Niskayuna, NY (US)

(73) Assignee: GENERAL ELECTRIC COMPANY, Schenectady, NY (US)

(21) Appl. No.: 13/536,330

(22) Filed: Jun. 28, 2012

(51) Int. Cl. H01G 9/155; H01G 9/00

(52) U.S. Cl. 361/502; 427/80

(57) ABSTRACT

An electrochemical capacitor, and a method of making the electrochemical capacitor, utilizing a non-spontaneous polarization dielectric material is disclosed. The use of a non-spontaneous polarization dielectric material increases the working or operating voltage and energy density of electrochemical capacitors.

### FIELD OF THE INVENTION

The present invention generally relates to capacitors. More particularly, this invention relates to electrochemical capacitor structures, and to methods for fabricating such structures.

### BACKGROUND

An electrochemical capacitor stores electrical charge in an electric double layer at the interface between an electrode and an electrolyte. One type of an electrochemical capacitor is an ultracapacitor. An ultracapacitor is an electrochemical capacitor with higher energy density as compared to conventional electrolytic or electrostatic capacitors. The energy density of an ultracapacitor is hundreds of times greater than the energy density of conventional capacitors.

An ultracapacitor has two electrode terminals separated by electrolyte and a separator. Each electrode terminal is formed of a conductive material supporting a conductive active layer. When connected to a voltage source, the conductive active layer on each electrode terminal attracts ions from the electrolyte disposed between the terminals. An ultracapacitor stores electrical energy by physical access of ions to the surface area in the electrode terminals. Ultracapacitors are able to recover energy from many repetitive processes, such as, for example, braking in cars or pitch systems in wind turbines.

The current energy density for an ultracapacitor is primarily limited by low operating voltage of less than 3V. Prior attempts have also been made to increase the working voltage and energy density of ultracapacitors. Traditionally, ultracapacitors have been improved by increasing the surface area of the electrode terminals which increases capacitance in linear proportion to the increase in the charge accumulation area. However, the surface area of the electrode terminals that can be accessed by charges is still very limited, with only a moderate increase in energy density. Other prior attempts have focused on the composition of the active conductive layers or the use of spontaneous electric polarization materials. However, spontaneous electric polarization materials have low dielectric strength and, therefore, limit the operating voltage that can be applied to a capacitor.

### SUMMARY

The present invention relates, in one aspect, to an apparatus comprising a first electrode, a second electrode, and an electrolyte and separator positioned between the first and second electrodes. The first electrode includes a first terminal and a first active layer, and the second electrode includes a second terminal and a second active layer. A first non-spontaneous polarization dielectric material is disposed on the first active layer. In one embodiment, a layer of first non-spontaneous polarization dielectric material is disposed on the first active layer. In alternative embodiments, a second non-spontaneous polarization dielectric material is disposed on the second active layer of the second electrode.

In another aspect of the present invention, a method of forming a capacitor is provided that comprises providing a first electrode including a first terminal and a first active layer, providing a second electrode including a second terminal and a second active layer; and disposing an electrolyte and a separator between said first and second active layers. The method further comprises disposing a first non-spontaneous polarization dielectric material on the first active layer of the first electrode.

Additional features and advantages are realized through the techniques of the present invention. Other embodiments and aspects of the invention are described in detail herein and are considered a part of the claimed invention.

### BRIEF DESCRIPTION OF THE FIGURES

FIG. 1 illustrates an EDLC capacitor embodiment of the present invention.

FIG. 2 illustrates an aluminum oxide dielectric layer on a surface of an activated carbon layer.

FIG. 3 illustrates an amount of improvement in working voltage (AC) performance in an EDLC due to a 2 nm dielectric coating on its terminals as compared to an uncoated EDLC.

FIG. 4 illustrates ultracapacitor impedance using a 4 nm thick dielectric coating on its terminals and impedance of a reference capacitor having uncoated terminals.

FIGS. 5A-5B illustrates improved alternating voltage tolerance of an ultracapacitor embodiment of the present invention due to a 4 nm dielectric layer on its terminals as compared to a reference capacitor without the dielectric layer.

### DETAILED DESCRIPTION

Generally stated, disclosed herein is an electrochemical capacitor employing a non-spontaneous electric polarization dielectric material disposed on at least one of its conductive active layers, and a method of fabrication thereof. The disposition of a non-spontaneous electric polarization dielectric material in accordance with one or more aspects of the present invention can be employed on any type of new or existing electrochemical capacitors configuration using any type of electrolyte between the active conductive layers. One type of a high density capacitor is an ultracapacitor.

Examples of ultracapacitors include an electrochemical double layer capacitor (EDLC) and an electrochemical pseudocapacitor. An electrical double layer capacitor (EDLC) stores energy through ion adsorption. The charge transfer process in EDLCs is non-faradic, for example, electron transfer across the electrodes does not occur, and thus the accumulation of charge is purely electrostatic. EDLC are typically constructed in a symmetric electrode design utilizing the same electrode materials such as activated carbon or graphene for both active conductive layers. Pseudocapacitors store energy through fast redox reactions between the electrolyte and the electroactive species on the electrode surface. Electron transfer causes charge accumulation in the pseudocapacitor and the charge transfer process is faradaic in nature. Pseudocapacitors are typically constructed in an asymmetric electrode design utilizing different electrode materials such as, for example, activated carbon on one electrode and LiMnO₂ on the opposite electrode.

Electrochemical capacitors such as, for example, ultracapacitors, when subjected to high voltage, will eventually break down at the interface of an active conductive layer made from, for example, carbon, and an electrolyte. Higher voltage and smaller ion particles in the electrolyte also cause the electrolyte to degrade more quickly over time. Smaller ions tend to cause more ion leakage through the conductive active layer, thereby depleting and degrading the electrolyte. The accumulating charges on the surface of, for example, carbon are gradually consumed due to charge leakage until, at breakdown, the remaining charge (ions) in the electrolyte are insufficient for the capacitor to function properly. Since the charge accumulating on the surface of, for example, the carbon is exponentially proportional to voltage, the higher the operating voltage of the capacitor, the more electrolyte charge is consumed. As more electrolyte charge is consumed, the degradation of the electrolyte increases resulting in lower capacitance, greater impedance, and lower energy density. Eventually, the degraded capacitor must be replaced.

An electrochemical capacitor constructed in accordance with one or more aspects of the present invention significantly increases the operating or working voltage and capacitance of an electrochemical capacitor by increasing the capability of the electrode terminals to withstand higher operating voltages by, for example, approximately two or more times compared to conventional EDLC ultracapacitor devices. The significant increase in operating voltage and capacitance due to the disposition of a non-spontaneous polarization dielectric material on each of the capacitor's conductive active layers increases energy density. For example, an energy density of 10-30 Wh/kg can be achieved in a typical ultracapacitor using activated carbon terminals. More than 100 Wh/kg is potentially possible in an ultracapacitor using nano-enabled pseudocapacitance as described herein. This significant voltage increase surpasses any minor adverse effects of surface area reduction that may occur due to the dielectric material on the conductive active layer.

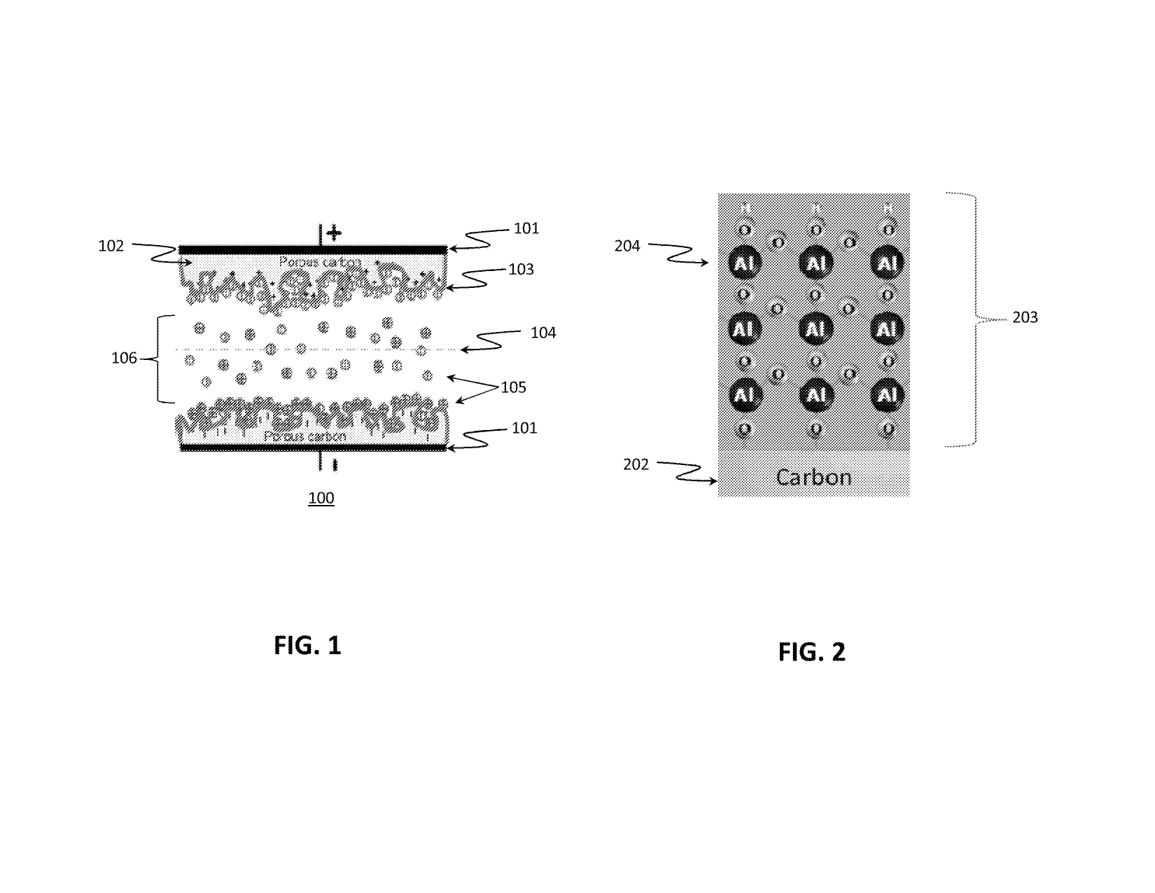

By way of example, FIG. 1 depicts an electrochemical capacitor 100. The electrochemical capacitor 100 depicted in FIG. 1 includes two electrode terminals 101 formed of a conductive material. Electrode terminals 101 may be made from, for example, any suitable conductive material that emits or collects electrons or holes or is an electrical conductor used to make contact with a non-metallic part of a circuit. In some embodiments, the term electrode comprises the current collector along with the electrode connected thereto. In other embodiments, the electrode comprises conductive polymers, carbon, nanomaterials or cellulose. In one embodiment, electrodes may be carbon. Carbon electrodes may include, for example, single-walled carbon nanotubes, fullerenes, multi-walled carbon nanotubes, diamond-like carbon, diamond, nanocrystalline diamond diamondoids, amorphous carbon, carbon particles, carbon powder, microspheres, graphite, graphene, carbon fiber, carbon felt, graphitic polyhedral crystals, highly ordered pyrolytic graphite, actived carbon, xerogels, aerogels, nanostructured carbon or hydrogenated amorphous carbon.

Electrode terminals 101 are connected to a voltage source and each terminal is connected to a conductive active layer 102. When connected to a voltage source of, for example, an EDLC, the conductive active layer 102 on each electrode terminal attracts ions from an electrolyte 106 disposed between the terminals. The polarity of each conductive terminal is indicated by the +/− symbols.

Electrolyte 106 is disposed between the conductive terminals 101. Electrolyte 106 comprises positive and negative ions 105 that are attracted to a corresponding (oppositely charged) one of the terminals. In one embodiment, electrolyte 106 comprises any composition that can be used to electrically conduct charge in an electrochemical capacitor. In one embodiment, electrolyte 106 may include, but is not limited to, aqueous solutions such as KOH and KI; acid solutions such as H₂SO₄, and Na₂SO₄; organic electrolytes such as Tetraethyl Ammonium Tetrafluoroborate (TEABF4) in propylene carbonate (PC), and acetonitrile (AN); and ionic liquid electrolyte such as 1-ethyl-3-methylimidazolium tetrafluoroborate, 1-ethyl-3-methylimidazolium bis(trifluoromethylsulfonyl)imide, trimethylsulfonium bis(trifluorosulfonimide), and 1-butyl-3-methylimidazolium. Aqueous and acid solutions may also be used, which provide higher capacitance due to smaller ionic size which allows greater charge accumulation. However, this capacitance increase is not as great as that contributed by the organic electrolytes. Ionic liquid electrolyte has relatively higher operating voltage compared to organic electrolyte because of its large ion size. In other embodiments, organic alternatives, such as, for example, Tetraethyl Ammonium Tetrafluoroborate (TEABF4) in propylene carbonate (PC), and acetonitrile (AN) are operable at higher voltages due to the larger size of their ionic particles which provide some resistance to degradation via ion leakage through the terminal layers.

In one embodiment, an electrochemical capacitor 100 includes a separator 104 positioned in the electrolyte 106 between conductive terminals 101. Separator 104 is an insulator that prevents electrons from traveling through. Examples of insulators include, but are not limited to, oxides, hydroxides, halides, hydrides, self-assembled monolayers, plastics and polymers.

As shown in the example depicted in FIG. 1, the electrochemical capacitor 100 includes electrode terminals 101 each supporting a conductive active layer 102. A desirable property in these conductive active layers is high charge storage capability (capacity). There is, however, a tradeoff between high storage capacity and resistance to degradation, such as ion leakage through the active material. Depending on particular applications, higher capacitance can be traded off for useful lifetime. Thus, materials that are more prone to degradation and which support lower numbers of charge/discharge cycles can be useful for applications where number of cycles is not as crucial as capacitance.

In one embodiment, the conductive active layer 102 is formed from activated carbon. The activated carbon layer may comprise, for example, carbon particles held together with a binder; the activated carbon layer is electrically conductive across the thickness of the terminal, so there is a conducting path from the interface between the carbon layer and the electrolyte to the metallic terminal substrate. In this embodiment, ions from electrolyte 106 occupy the large surface area of the porous carbon material creating a high capacitance structure. In, for example, conventional EDLCs, because the charges reside on the surface of the carbon layer, the size of the ions from the electrolyte determine the operating voltage of the device, typically in the range of 2.5V-3V, as well as its breakdown voltage.

In an alternative embodiment, conductive active layer 102 may include, for example, carbon nanotubes deposited on a terminal of aluminum foil. In yet another embodiment, conductive active layer 102 includes, for example, graphene. Graphene provides a high surface area and is a good conductor. Other suitable materials for conductive active layer 102 may include, for example, carbon nanotubes, graphene, carbon nanofiber, and lithium titanate (Li₄Ti₅O₁₂). In an embodiment where the high density capacitor is asymmetric, where a material such as, for example, activated carbon, carbon nanotubes, graphene, carbon nanofiber, or lithium titanate is employed on a negative terminal, then the positive terminal may, for example, employ MnO₂, PbO₂, PbC, LiPF₆, LiCoO₂, or LiMnO₂.

In one embodiment, a non-spontaneous polarization dielectric material 103 is deposited on at least one of conductive active layer 102. In an alternative embodiment, dielectric material 103 may form a layer overlaying conductive active layer 102. Dielectric material 103 strengthens the interface between conductive active layer 102 and electrolyte 106 against charge (ion) penetration. Using a non-spontaneous polarization dielectric layer 103, conductive active layer 102 can better withstand higher operating voltages while providing increased energy density. In some embodiments, for example to promote even higher operating voltages in a symmetric EDLC capacitor, the dielectric material can be deposited on both conductive active layers 102. In other embodiments, such as for a pseudocapacitor, dielectric material may only be deposited on one of the conductive active layers.

In general, a dielectric material is a substance that is a poor conductor of electricity. Dielectric materials may be classified as non-spontaneous polarization (net polarization is zero) and spontaneous polarization (net polarization is non-zero). A non-spontaneous polarization dielectric material contains non-polar molecules or weak polar molecules, and does not exhibit spontaneous polarization due to neutrality of molecules or random orientations of polar molecules when no electric field is applied. An applied electric field will polarize a non-spontaneous polarization dielectric material by inducing dipoles from distorted electron clouds, or by orienting the dipole moments of polar molecules. The polarization is almost exactly proportional to the applied external electric field so the polarization is a linear function. Once the external field is removed, the net polarization becomes zero.

In contrast, a spontaneous polarization dielectric material possesses a spontaneous electric polarization (non-zero) under zero applied electric field. Examples of spontaneous polarization dielectric materials are ferroelectrics, which are also piezoelectric and pyroelectric materials due to crystalline symmetry considerations. In addition to showing a nonlinear relationship between polarization and applied electric field, ferroelectric materials demonstrate a spontaneous nonzero polarization when the applied field is zero. Unlike non-spontaneous polarization dielectric materials, an applied electric field can be reversed with spontaneous polarization dielectric materials. The spontaneous polarization of these types of dielectric materials are accompanied by a hysteresis effect, because the polarization is dependent not only on the current electric field but also on its history.

Non-spontaneous polarization dielectric materials have significant advantages over spontaneous polarization dielectric materials when used in accordance with one or more aspects of the present invention. For example, non-spontaneous polarization materials exhibit higher dielectric strength as compared to spontaneous polarization dielectric materials. With higher dielectric strength, a higher working or operating voltage can be applied to the electrode terminals without causing breakdown.

Examples of non-spontaneous dielectric materials include, for example, aluminum oxide (such as Al₂O₃, and AlOx, where x=1-1.5) and/or silicon oxide (such as SiO₂, and SiOx, where x=1.5-2). These materials have high dielectric strength and a low dielectric constant. Aluminum oxide and silicon oxide are, for example, simpler to control in a gas deposition process because of their facility to be provided as a gaseous precursor. In another embodiment, dielectric material 103 may include, for example, Zirconium oxide (such as ZrO₂, and ZrOx, where x=1.5-2), hafnium oxide (such as HfO₂, and HfOx, where x=1.5-2), Silicon Nitride (such as Si₃N₄, and SiNx, where x=1-1.5), Boron Nitride (such as BN), and/or tantalum oxide (such as Ta₂O₅, and TaOx, where x=2-2.5) or titanium oxide (such as TᵢO₂, and TiOx, where x=1.5-2), which have high dielectric strength and a moderate dielectric constant. In yet another embodiment, dielectric layer 103 may include, for example, the organic materials polyimide, polyetherimide, PTFE (Teflon), and Cyanoresin, which may also be selected based on their dielectric strength. Other examples of non-spontaneous dielectric materials 103 include, but are not limited to, MgO, CaO, Y₂O₃, Sc2O₃, Fe₂O₃, La₂O₃, Nd₂O₃, Sm₂O₃, Yb₂O₃, Lu₂O₃, Pr₂O₃, CeO₂, Er₂O₃, Dy₂O₃, Dy₂O₃, Gd₂O₃, Eu₂O₃, Bi₂O₃, BeO, AlON, ZnO, MgTiO₃, CaTiO₃ and DLC (diamond like carbon), and their non-stoichiometric formulations, such as MeOx, where Me stands for a metallic element and x=1-3.

Non-spontaneous polarization dielectric materials such as, for example, silicon oxide, silicon nitride and aluminum oxide exhibit breakdown strength above 10 MV/cm (i.e., 1 V/nm), which provide the ability to use a higher operating voltage in an electrochemical capacitor. The increase in operating voltage results increasing the energy density and decreasing the number of capacitor cells and interconnects between capacitors in practical devices. On the other hand, ferroelectric materials with spontaneous polarization exhibit lower breakdown voltage. For example, strontium titanate ceramic will fail electrically at <0.23V/nm. Barium strontium titanate ceramic breaks down at <0.2 V/nm. Lead zirconate ceramic breakdowns at 0.18V/nm, lead zirconate titante ceramics breakdowns at 0.08V/nm. Because of the low breakdown strength of the spontaneous polarization dielectric materials, they are not able to handle an increase in the operation voltage of a capacitor, and typically are used to only increase the capacitance.

In accordance with one or more aspects of the present invention, a process is provided for forming an electrochemical capacitor. In one embodiment, the process includes providing a first and a second conductive terminal, electrolyte and a separator in the electrolyte between the first and second conductive terminals, and disposing a conductive layer on at least one of the first and second conductive terminals. In one embodiment, a non-spontaneous polarization dielectric material is disposed on the conductive layer.

In one embodiment, a dielectric material is disposed on an active conductive layer by, for example, atomic layer deposition (“ALD”). ALD provides good control in depositing monolayer increments with depth controlled by the number of process repetitions used. ALD's advantages include the deposition of precursors in a gas phase which provides good uniformity and conformal penetration. In one embodiment, ALD, using, for example, a Savannah 100 ALD system as commercially provided by Cambridge NanoTech, is employed to coat porous activated carbon terminals with alumina. In one illustrative example of an embodiment, the carbon terminals may be first fixed, before the deposition of the dielectric material, the carbon terminals were first fixed on, to a silicon wafer with Kapton tape and degased inside the ALD chamber at 150° C. with constant nitrogen flow of 20 sccm for approximately two hours (2 h). In one embodiment, rimethyl aluminum (TMA) and deionized water (vapor) were introduced to the chamber as precursors for the alumina deposition.

The carbon surface of the terminals is considered a rough tortuous surface having a depth that can reach, in some cases, up to approximately 100 microns. The extent to which the deposited dielectric layer conforms to the tortuous surface of the conductive active layer, and the uniformity of coating coverage on the surface, depends in part on the ability of the precursor material to penetrate into the high-aspect-ratio features of the surface. A shallower conductive active layer would not require infiltration of the dielectric material to such a depth. Due to this high aspect ratio feature of the carbon covered terminals, an exposure mode may be used, in one embodiment, for the deposition, wherein reactants introduced into the deposition chamber as gases are supplied to the chamber in pulses at preselected times, with each pulse resulting in a reaction of the gases with the substrate surface, and are separated from one another in the process using purging steps which comprise neutral gases flowed through the chamber.

Each repetition of the process step results in approximately one layer (monolayer) of dielectric being deposited on the conductive active layer, and may be repeated many times until a desired dielectric thickness is achieved. With about 30 process repetitions using the precursors described above approximately a 4-7 nm thick coating of dielectric material, such as, for example, aluminum oxide is deposited. A thickness up to about 20 nm can also be achieved by increasing a number of the process repetitions. In one example of deposition cycle for a layer of aluminum oxide, a computer-controlled pneumatic exhaust valve between the flow chamber and the exhaust pump was closed first, and four sequential pulses of TMA were introduced into the chamber with a pulse time of 0.015 seconds (s) and waiting time of 30 s in between. Nitrogen flow rate was kept at 5 sccm during the TMA pulses. After dwelling for 150 s after the fourth TMA pulse, the pneumatic exhaust valve was opened and the reaction chamber was purged with nitrogen (argon can also be used) at a flow rate of 20 sccm for 360 s. The same sequence may be used for the H₂O half cycle except that the pulse time of water vapor was increased to 0.03 s. This process may be repeated for 30, 40, 80, and 100 cycles for different samples to provide alumina coatings with different thicknesses.

FIG. 2 illustrates one embodiment of a dielectric layer 203 comprising an aluminum oxide coating 204 on a carbon surface 202 using the exemplary deposition process described above. Aluminum oxide coating 204 shown in FIG. 2 comprises an illustration of three monolayers of aluminum oxide which results after approximately three repetitions of the process described above. Several more monolayers are deposited via repeated process steps to achieve a thickness of approximately 2 nm up to about approximately 7 nm. A 20 nm thickness may also be achieved using more repetitions. Because capacitance also increases with respect to the square of the voltage, dielectric thickness can be fine tuned to increase capacitance without unnecessarily sacrificing surface area.

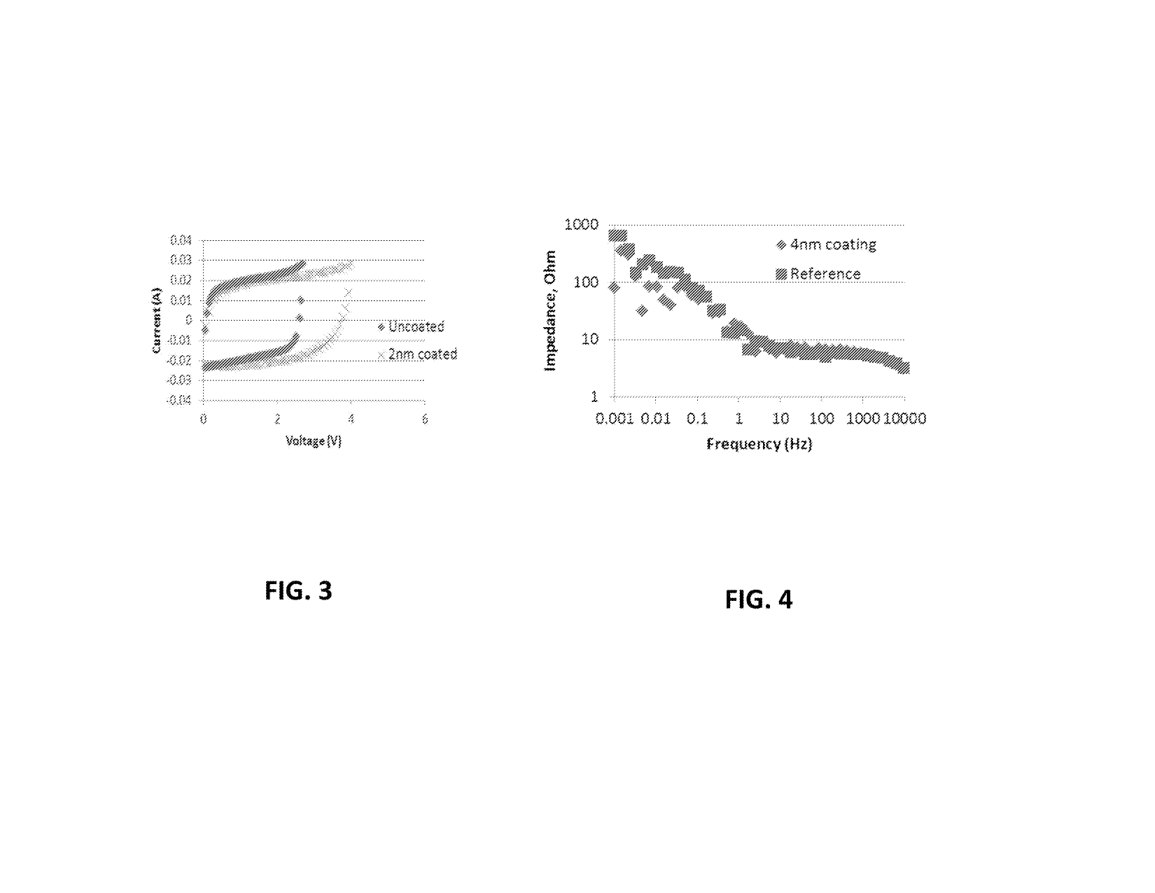

FIG. 3 depicts a graph of current/voltage performance of an ultracapacitor including a dielectric coating deposited on its terminals using the deposition method as described above. The operating voltage is shown to have increased from about 2.7V for a reference capacitor with uncoated terminals to about 4V for a capacitor having a dielectric deposition of about 2 nm thickness.

FIG. 4 depicts a graph of impedance/frequency performance of an uncoated reference capacitor and a capacitor including a dielectric coating of about 4 nm deposited on its terminals using the method as described above. The graph demonstrates that impedance remains substantially equivalent as between capacitors having uncoated terminals and dielectric-coated terminals, in particular at higher frequencies.

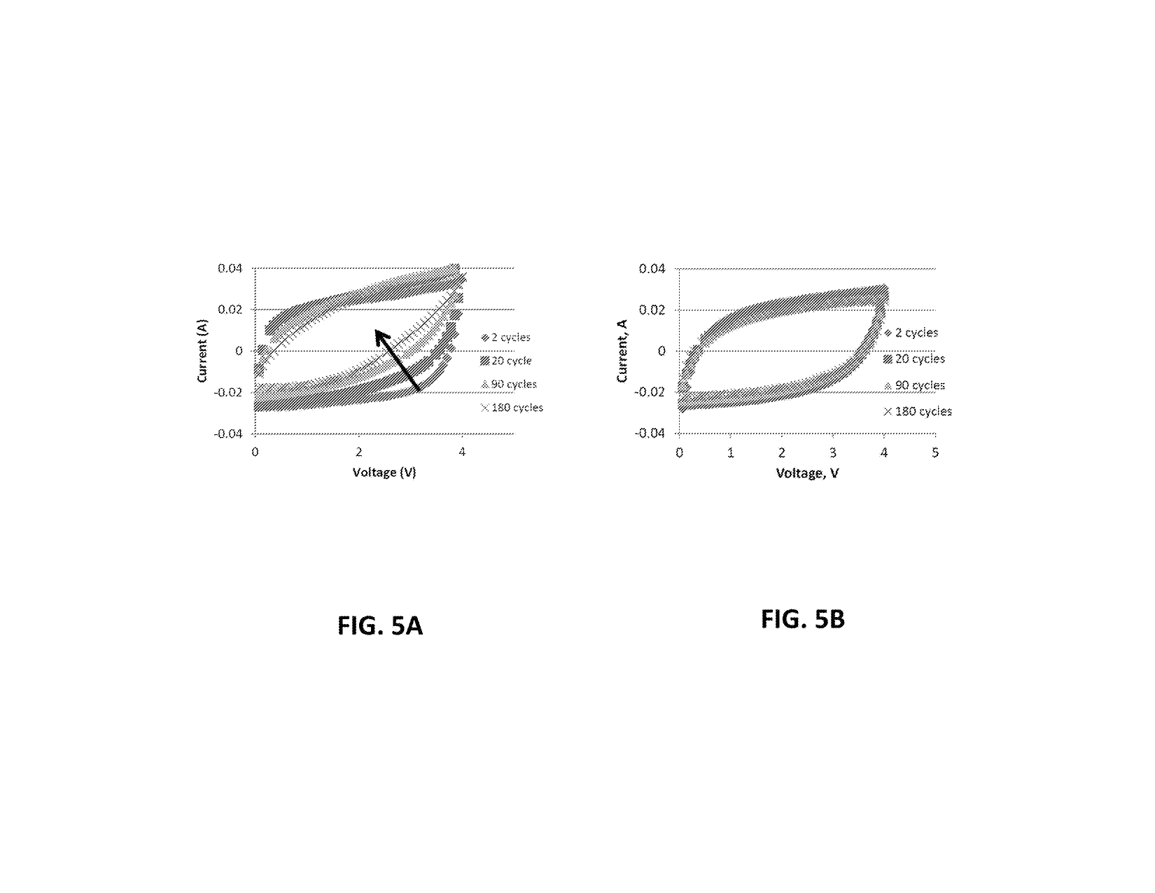

FIGS. 5A and 5B depict graphs of current/voltage performance of a reference ultracapacitor without a dielectric coating on its terminals (FIG. 5A) and an electrochemical capacitor with an approximately 4 nm thick dielectric layer on its terminals (FIG. 5B), using the deposition method as described above, are illustrated. The reference capacitor performance decreases with increasing number of charge/discharge cycles, as shown by its decreasing current carrying capability at the same operating voltage (highlighted by the dark arrow of FIG. 5A). The performance of the capacitor with a deposited dielectric layer is substantially unchanged over the same range of charge/discharge cycles as shown by the data of FIG. 5B.

Alternative processes for depositing the dielectric layer onto the active conductive layer include, for example, solution deposition, plasma enhanced chemical vapor deposition (PECVD), flow CVD, and physical vapor deposition. Solution deposition is useful in depositing organic dielectrics because the polymer can be dissolved in a solvent to make a dilute solution that infiltrates the porous conductive active layer on the terminal which, after a drying step, leaves the dielectric material on the conductive active layer. Inorganic dielectric material can also be deposited using solution deposition. Flow CVD is a CVD process modified for better infiltration. Physical vapor deposition begins with solid material and generates a plasma using ionic bombardment in a vacuum chamber. In general, the better the penetration depth and conformal coating capability of the dielectric, the less electrolyte degradation occurs and so its reliability increases. Better conformal properties result in less adverse effect on the surface area of the active layer.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An apparatus, said apparatus comprising:
a first electrode, said first electrode including a first terminal and a first active layer, wherein a first dielectric material is disposed on the first active layer, the first dielectric material comprising a non-spontaneous polarization dielectric material;
a second electrode, said second electrode including a second terminal and a second active layer;
electrolyte separating said first and second electrodes; and
a separator in the electrolyte between said first and second electrodes.

2. The apparatus of claim 1, wherein said first and second electrodes are connected to a voltage source, the voltage source comprising an alternating voltage source or a DC voltage source.

3. The apparatus of claim 1, wherein the first non-spontaneous polarization dielectric material disposed on the first active conductive layer forms a layer overlaying the first active conductive layer.

4. The apparatus of claim 3, wherein the layer of dielectric material comprises a thickness of about 1 nm.

5. The apparatus of claim 3, wherein the layer of first non-spontaneous polarization dielectric material comprises a thickness of about 20 mm.

6. The apparatus of claim 3, wherein the layer of first non-spontaneous polarization dielectric material comprises a thickness between about 2 nm and about 10 nm.

7. The apparatus of claim 1, wherein a second non-spontaneous polarization dielectric material is disposed on the second active layer.

8. The apparatus of claim 1, wherein the first active layer and the second active layer are made from the same material.

9. The apparatus of claim 1 wherein the first non-spontaneous polarization dielectric material comprises aluminum oxide or silicon oxide, or a combination thereof.

10. The apparatus of claim 1, wherein the first non-spontaneous polarization dielectric material comprises tantalum oxide, silicon nitride or hafnium oxide, or a combination thereof.

11. The apparatus of claim 1, wherein the first non-spontaneous polarization dielectric material comprises ZrO₂, BN, TᵢO₂, MgO, CaO, Y₂O₃, Sc2O₃, Fe₂O₃, La₂O₃, Nd₂O₃, Sm₂O₃, Yb₂O₃, Lu₂O₃, Pr₂O₃, CeO₂, Er₂O₃, Dy₂O₃, Dy₂O₃, Gd₂O₃, Eu₂O₃, Bi₂O₃, BeO, AlON, ZnO, MgTiO₃, CaTiO₃ or DLC (diamond like carbon). or their non-stoichiometric formulations, or polyimide, polyetherimide, PTFE (Teflon), or Cyanoresin, or combinations thereof.

10. The apparatus of claim 1, wherein said apparatus is an ultracapacitor.

11. The apparatus of claim 10, wherein said apparatus is an EDLC.

12. A method of forming a capacitor comprising:
providing a first electrode, said first electrode including a first terminal and a first active layer;
disposing a first dielectric material on the first active layer of the first electrode, wherein said first dielectric material is a non-spontaneous polarization dielectric material;
providing a second electrode, said second electrode including a second terminal and a second active layer; and
disposing an electrolyte and a separator between said first and second active layers.

13. The method of claim 12, wherein a layer of first non-spontaneous polarization dielectric material is deposited on the first active layer.

14. The method of claim 13, wherein the layer of first non-spontaneous polarization dielectric material is formed by atomic layer deposition.

15. The method of claim 12, wherein the first non-spontaneous polarization dielectric material comprises aluminum oxide or silicon oxide, or a combination thereof.

16. The apparatus of claim 12, wherein the first non-spontaneous polarization dielectric material comprises tantalum oxide, silicon nitride or hafnium oxide, or a combination thereof.

17. The apparatus of claim 12, wherein the first non-spontaneous polarization dielectric material comprises ZrO₂, BN, TᵢO₂, MgO, CaO, Y₂O₃, Sc2O₃, Fe₂O₃, La₂O₃, Nd₂O₃, Sm₂O₃, Yb₂O₃, Lu₂O₃, Pr₂O₃, CeO₂, Er₂O₃, Dy₂O₃, Dy₂O₃, Gd₂O₃, Eu₂O₃, Bi₂O₃, BeO, AlON, ZnO, MgTiO₃, CaTiO₃ or DLC (diamond like carbon). or their non-stoichiometric formulations, or polyimide, polyetherimide, PTFE (Teflon), or Cyanoresin, or combinations thereof.

18. The method of claim 14, a layer of approximately 1 nm of first non-spontaneous polarization dielectric material is disposed on the first active layer.

19. The method of claim 14, wherein a layer of approximately 20 nm of first non-spontaneous polarization dielectric material is disposed on the first active layer.

20. The method of claim 14, wherein a layer of between approximately 1 nm and 20 nm of first non-spontaneous polarization dielectric material is disposed on the first active layer.

21. The method of claim 12, further comprising depositing a second dielectric material on the second active layer of the second electrode.

22. The method of claim 21, wherein a layer of second dielectric material is deposited on the second active layer.

23. A method comprising:
depositing a dielectric material on a conductive active layer of a capacitor terminal, wherein the dielectric material comprises a non-spontaneous polarization dielectric material.

24. The method of claims 23, further comprising forming a layer of the non-spontaneous polarization dielectric material on the conductive active layer.

25. The method of claim 23, wherein the first non-spontaneous polarization dielectric material comprises aluminum oxide or silicon oxide, or a combination thereof.

26. The apparatus of claim 23, wherein the first non-spontaneous polarization dielectric material comprises tantalum oxide, silicon nitride or hafnium oxide, or a combination thereof.

27. The apparatus of claim 23, wherein the first non-spontaneous polarization dielectric material comprises ZrO₂, BN, TᵢO₂, MgO, CaO, Y₂O₃, Sc2O₃, Fe₂O₃, La₂O₃, Nd₂O₃, Sm₂O₃, Yb₂O₃, Lu₂O₃, Pr₂O₃, CeO₂, Er₂O₃, Dy₂O₃, Dy₂O₃, Gd₂O₃, Eu₂O₃, Bi₂O₃, BeO, AlON, ZnO, MgTiO₃, CaTiO₃ or DLC (diamond like carbon). or their non-stoichiometric formulations, or polyimide, polyetherimide, PTFE (Teflon), or Cyanoresin, or combinations thereof.

28. The method of claim 24, wherein the step of forming the dielectric layer comprises atomic layer deposition.
